(19) United States
(12) Patent Application Publication
(10) Pub. No.: US 2009/0224597 A1
(43) Pub. Date: Sep. 10, 2009

(54) Wheel cavity flow control device and method for reducing the aerodynamic drag of ground vehicles

(75) Inventor: Richard Wood, Virginia Beach, VA (US)

Correspondence Address: Richard M. Wood, 754 Suffolk Lane, Virginia Beach, VA, 23452, US

(73) Assignee: SOLUS-Solutions and Technologies LLC

(21) Appl. No.: 12/378,881

(22) Filed: Feb. 20, 2009

Related U.S. Application Data
(60) Provisional application No. 61/068,437, filed on Mar. 7, 2008.

(51) Int. Cl. B60B 25/00

(52) U.S. Cl. 301/35.61; 301/35.621

(57) ABSTRACT

The invention relates to the reduction of aerodynamic drag for moving ground vehicles; specifically to an improved method and device for the reduction of aerodynamic drag of ground vehicles by reducing the mass and velocity of the flow interacting with the cavity of a wheel. The flow passing around a ground vehicle imparts a drag force to the vehicle when it interacts with a wheel. The ground vehicle class of particular interest is a tractor-trailer truck system consisting of a motorized lead vehicle pulling one or more non-motorized vehicles. The subject invention is designed to control the flow from entering the cavity of a wheel from the side of a ground vehicle system.

### CROSS-REFERENCE TO RELATED APPLICATION

This application claims benefit of U.S. Provisional Application No. 61068437, filed Mar. 3, 2008, the entire content of which is incorporated herein by reference.

### ORIGIN OF THE INVENTION

The invention described herein was made by employees of the United States Government, and may be manufactured and used by or for the Government without payment of any royalties thereon or therefor.

### FIELD OF INVENTION

The invention relates to the reduction of aerodynamic drag for moving ground vehicles; specifically to an improved method and device for the reduction of aerodynamic drag and for improved performance of ground vehicles by reducing the mass and velocity of the air interacting with the wheel cavity. The air passing around a ground vehicle imparts a drag force to the vehicle when it flows into the cavity of a wheel and interacts with the outward facing surfaces of the wheel. The outward facing surfaces of a wheel is referred to as the wheel cavity. The ground vehicle class of particular interest is a motorized ground vehicle system. The subject invention controls the air passing over the wheel cavity and restricts air from entering the wheel cavity.

### BACKGROUND OF INVENTION

Prior art has attempted to reduce the aerodynamic drag of ground vehicles by reducing the aerodynamic drag of the wheels. For powered and un-powered vehicles with a large number of wheels the total wheel drag may comprise a significant portion of the total vehicle drag. The air passing around the tires and wheels of a vehicle will enter the outward facing wheel cavity referred to as the wheel cavity and interact with the surface of the wheel cavity resulting in low and high pressures acting on the wheel cavity surface which result in an aerodynamic drag force. Prior art has reduced wheel drag by fully covering the wheel cavity opening with a disc or panel that stops all air from entering the wheel cavity. These previous wheel cavity cover devices are circular in shape to match the wheel cavity opening and extended to the wheel outer rim. These previous devices typically attached to the wheel outer rim edge or other locations on the wheel structure. These devices were designed to prohibit external air passing over the outward facing external surfaces of the vehicle tire and wheel system from flowing into the wheel cavity and interacting with the wheel cavity surface. Several versions of these type of drag reduction devices were configured with openings in the covers to facilitate the movement of air from inboard of the tire and wheel assembly to flow into the cavity and then to the outer surface of the wheel cavity cover in an effort to promote air flow from inboard of the tire and wheel assembly through the wheel cavity to provide cooling to the brake systems.

Prior art that has used wheel cavity covers, see U.S. Pat. Nos. 6,820,475, 5,263,770, 5,135,289 and 6,794,178. These representative devices, while successful in reducing the mass of air interacting with the wheel assembly and thereby reducing the wheel drag, are complex devices that reduce access to the wheel cavity and therefore negatively impact operations and result in additional maintenance.

### SUMMARY OF THE INVENTION

The object of the invention is to reduce vehicle drag and thereby increase vehicle performance by; controlling the air passing over the outer facing surfaces of the tire and wheel assembly, restricting air flow from entering the wheel cavity, and changing the wheel cavity flow characteristics by positioning a specifically sized and shaped panel shaped device in a plane that is coincident with or in close proximity the outer opening of the wheel cavity. The laterally projected area of the subject device is less than the maximum wheel cavity open area. The shape of the subject device may be either rectilinear or curvilinear. The positioning of the subject device is accomplished with various attachment means. The subject device may be fabricated with various geometric and material modifications to support operational, maintenance, and aesthetic requirements without altering the aerodynamic performance and flow control function of the device. The flow control function of the subject device is accomplished by two means; first the mass and velocity of air entering the wheel cavity is restricted and secondly the flow characteristics of the air that enters the wheel cavity is modified such that the entrained air in the wheel cavity works in partnership with the subject device to fundamentally change the wheel cavity flow features from an open cavity flow condition to a closed cavity flow condition. The subject device attaches to the wheel, rim, hub, axle cover or hubcap through the use of an attachment bracket or fitting. The subject device may be fabricated with an integral attachment bracket or fitting as such the integrated device attaches to the wheel, rim, hub, axle cover or hubcap. The subject device is centered in the wheel cavity opening, positioned laterally near the outer edge of the wheel rim and is sized with a laterally projected area that is larger than the area defined by the hub maximum diameter but less than the area defined by the wheel rim maximum inner diameter. The subject device comprising the subject invention is a light-weight and rigid device that attaches to either the surface of the wheel, rim, hub, axle cover or hubcap by means of an attachment bracket or fitting.

The subject device controls the air entering the wheel cavity by modifying the flow in the wheel cavity from an open cavity flow condition to a closed cavity flow condition. The air flow within the wheel cavity, without the subject invention installed, behaves as an open cavity in which the high velocity freestream air flow turns into the wheel cavity and imparts a low pressure on the forward section of the wheel cavity and a high pressure on the aft section of the wheel cavity. The low and high-pressure regions in the wheel cavity combine to produce a drag force. The open cavity flow conditions occur when the depth of the wheel cavity is less than the wheel cavity outer edge maximum diameter. This high drag open cavity flow condition can be minimized by covering a portion of the wheel cavity opening which thereby results in an increase in the effective aerodynamic depth-to-width ratio of the wheel cavity resulting in the wheel cavity flow changing from a open cavity flow to a closed cavity flow condition. Closed cavity flow is characterized by the external flow bridging the cavity. The high velocity freestream air does not enter the wheel cavity this results in free stream static pressures acting over the majority of the wheel cavity and thus resulting in a low drag force.

The use of a subject device that partially covers the wheel cavity to fully block air from entering the wheel cavity provides several operational and maintenance advantages over that of prior art.
1. eliminates the buildup of debris and dirt
2. eliminates the buildup of ice
3. can rigidly attach to wheel or hub structure
4. attachment not susceptible to wheel deflection and deformation
5. less weight addition
6. compatible with all existing wheel mounted hub caps
7. lower complexity
8. provides access to wheel cavity
9. provides access to valve stems tire inflation systems
10. provides access to hub mounted instrumentation
11. provides access to all wheel mounted systems
12. provides access to all hub and axle systems

### OBJECTS AND ADVANTAGES

Several objects and advantages of the present invention are:
(a) to provide a novel process to reduce the aerodynamic drag of vehicles;
(b) to provide a means to use closed cavity flow effects to reduce aerodynamic drag;
(c) to provide a means to reduce the aerodynamic drag and improve the operational efficiency of vehicles;
(d) to provide a means to reduce the aerodynamic drag and improve the fuel efficiency of vehicles;
(e) to provide a means to conserve energy and improve the operational efficiency of vehicles;
(f) to provide a means to reduce the aerodynamic drag without a significant geometric modification to the existing vehicles;
(g) to provide an aerodynamic drag reduction device that uses a minimum of components;
(h) to allow the geometric details of each component to be variable to meet the specific needs of the application;
(i) to allow the shape, size, and position of each component to be variable to meet the specific needs of the application;
(j) to control flow from entering the wheel cavity resulting in a reduced aerodynamic drag of the subject vehicle;
(k) to allow the device to be fabricated as a number of independent segments and parts that may be attached to an existing vehicle;
(l) to allow the device to be fabricated as a single structure that may be applied to an existing vehicle;
(m) to allow the device to be fabricated as an integral part of a vehicle;
(n) to allow for optimal positioning of each segment on the vehicle wheel surface;
(o) to have minimum weight and require minimum volume within the vehicle;
(p) to have minimum maintenance requirements;
(q) to have no impact on operational requirements.

Further objects and advantages are to provide a device that can be easily and conveniently used to minimize aerodynamic drag on any ground vehicle for the purposes of improving the operational performance of the vehicle. Still further objects and advantages will become apparent from a consideration of the ensuing description and drawings.

### BRIEF DESCRIPTION OF THE DRAWINGS

The invention will be better understood in relation to the attached drawings illustrating preferred embodiments, wherein:

FIG. 1a is an oblique view of a single wheel, hub and tire system.

FIG. 1b is an oblique view of a dual wheel, hub and tire system.

FIG. 2a is a cross section view of a single wheel, hub and tire system.

FIG. 2b is a cross section view of a single wheel, hub and tire system showing the streamlines of the flow in the region of the wheel cavity.

FIG. 3a is an oblique view of a single wheel, hub and tire system with the subject invention installed.

FIG. 3b is an oblique view of a dual wheel, hub and tire system with the subject invention installed.

FIG. 4a is a cross section view of a single wheel, hub and tire system with the subject invention installed.

FIG. 4b is a cross section view of a single wheel, hub and tire system with the subject invention installed showing the streamlines of the flow in the region of the wheel cavity.

FIG. 5a is a cross section view of a single wheel, hub and tire system showing the critical dimensional parameters.

FIG. 5b is a cross section view of a single wheel, hub and tire system with the subject invention installed showing the critical dimensional parameters.

FIG. 6a are cross section views of a single wheel, hub and tire system with the subject invention illustrating hubcap attachment concept A.

FIG. 6b are cross section views of a single wheel, hub and tire system with the subject invention illustrating hubcap attachment concept B.

FIG. 6c are cross section views of a single wheel, hub and tire system with the subject invention illustrating wheel attachment concept A.

FIG. 7a through 7f are plan views of the subject invention illustrating various discoidal shape concepts.

FIG. 8a through 8e are cross section views of the invention illustrating various cross section concepts.

### DETAILED DESCRIPTION OF THE PREFERRED EMBODIMENTS

The following descriptions are of exemplary embodiments of the invention only, and are not intended to limit the scope, applicability or configuration of the invention in any way. Rather the following description is intended to provide a convenient illustration for implementing various embodiments of the invention. As will become apparent, various changes may be made in the function and arrangement of the elements described herein without departing from the spirit and scope of the invention. For example, though not specifically described, many shapes, widths, diameters, placements, edge shapes, and orientation of the invention should be understood to fall within the scope of the present invention. The invention is applicable to all vehicles with wheels. The invention is not limited by fabrication means and material, attachments means and material such that all fabrication and attachment means and material should be understood to fall within the scope of the present invention.

Referring now in detail to the drawings, like numerals herein designate like numbered parts in the figures.

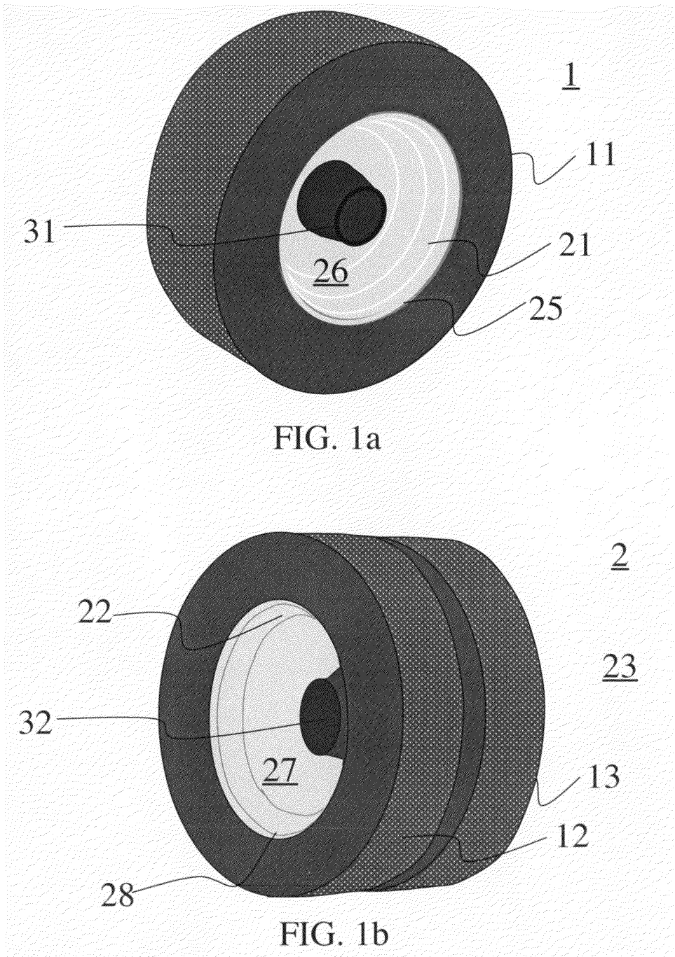

Ground vehicle wheel and tire systems are typically either single tire-and-wheel assemblies or dual tire-and-wheel assemblies as shown in FIG. 1. FIG. 1a shows an oblique view of a typical ground vehicle single tire and wheel assembly 1. The assembly 1 is comprised of a tire 11 and wheel 21 that mounts to the vehicle by a mechanical attachment to the wheel hub 31. The shape and structure of a wheel 21 typically results in a wheel cavity 26. The wheel cavity 26 is the wheel outward facing surface located inboard of the wheel outer rim 25.

FIG. 1b shows an oblique view of a ground vehicle dual tire and wheel assembly 2. The assembly is comprised of an outer tire 12, outer wheel 22, inner tire 13, and inner wheel 23 (not shown) that mount to the vehicle by a mechanical attachment to the wheel hub 32. The shape and structure of a wheel 22 typically results in a wheel cavity 27. The wheel cavity 27 is the outward facing surface of the wheel located inboard of the wheel outer rim 28.

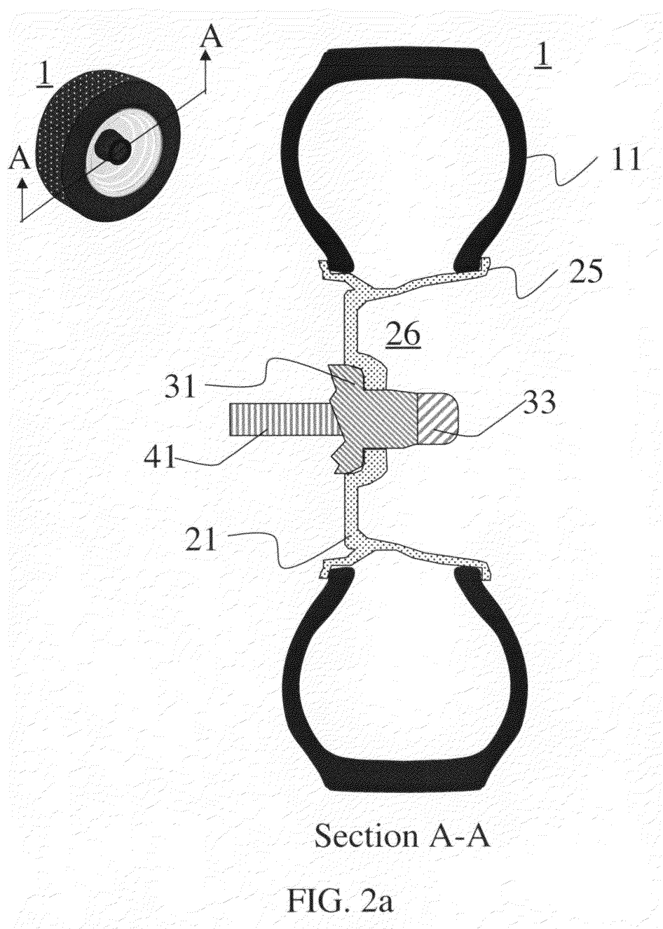

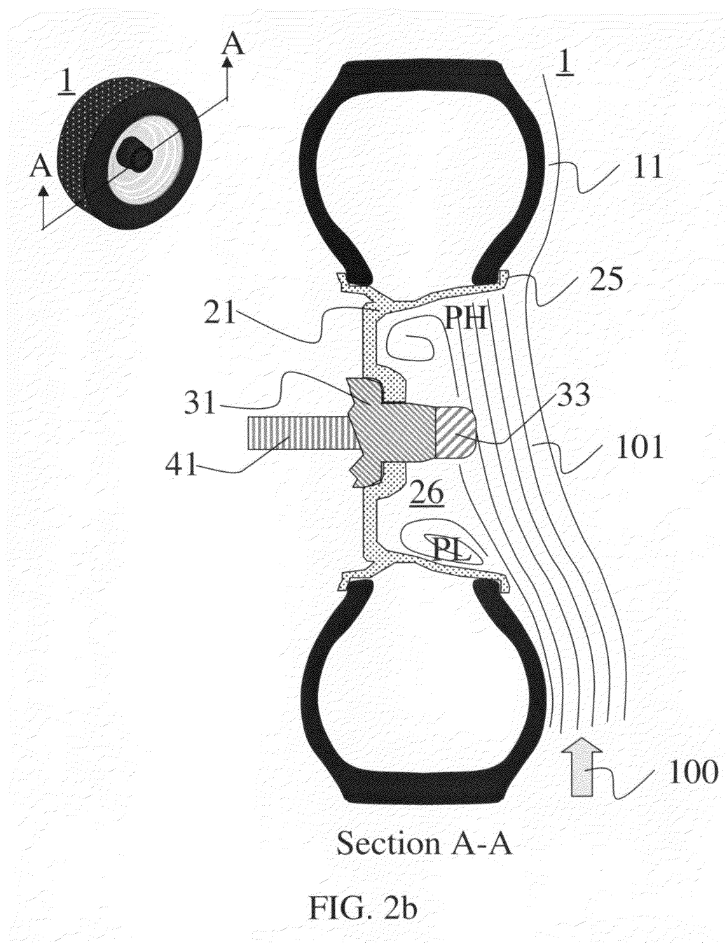

The wheel cavity 26 of a single wheel assembly 1 and the wheel cavity 27 of a duel wheel assembly 2 have similar geometric characteristics. For this reason the details of a wheel assembly and the air flow features will be discussed for a single wheel assembly 1 in FIG. 2.

Cross section cuts through a single wheel assembly 1 are provided in FIG. 2 to describe the air flow features in a wheel cavity 26. FIG. 2a shows a cross section view A-A through a single tire and wheel assembly 1. The section view shows a typical relationship between the tire 11, wheel 21, hub 31, axle 41 and hub/axle cover 33. FIG. 2a shows the wheel cavity 26 located inboard of the wheel outer rim edge 25.

FIG. 2b shows a cross section view A-A of the single tire and wheel assembly 1 and the air flow-streamlines passing over and into the wheel cavity 26. The cross section view shows a typical relationship between the tire 11, wheel 21, and hub 31. FIG. 2b shows the wheel outer rim edge 25 and the wheel cavity 26 that is located inboard of the wheel outer rim 25. The free-stream air flow-direction 100 is opposite that of the vehicle direction. The air flow-streamlines 101 flow into the wheel cavity 26 where they expand about the forward portion of the wheel outer rim edge 25 and generate a low pressure PL on the forward portion of the wheel cavity 26. The air flow entering the wheel cavity 26 also impinge on the aft portion of the wheel cavity 26 where they generate a high pressure PH on the aft portion of the wheel cavity 26. The area of low pressure PL and area of high pressure PH increase the drag force on the vehicle. The air flow-streamlines 101 reflect the general behavior of the air passing over a rotating wheel assembly 1.

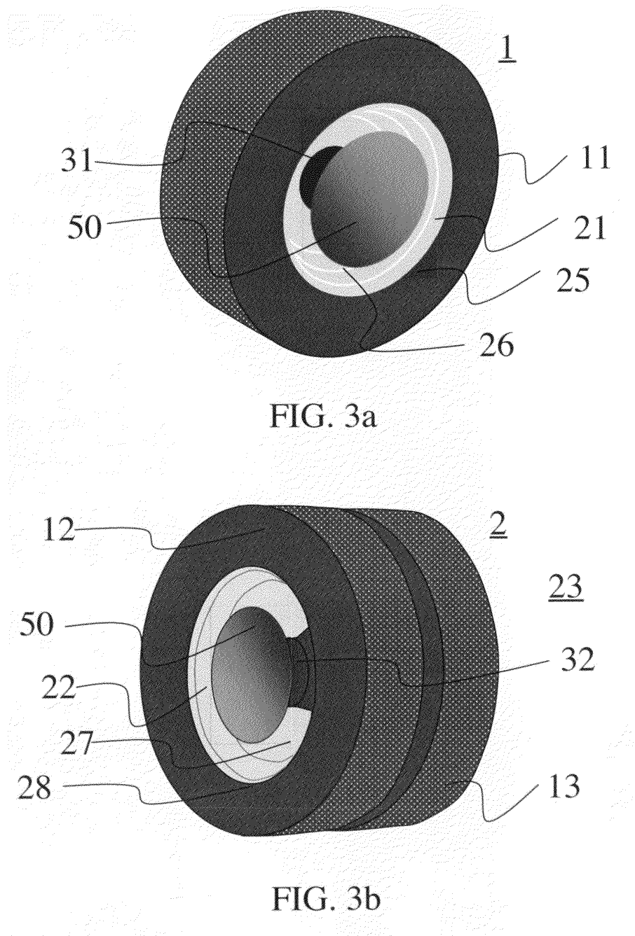

To control the air passing over a rotating tire and wheel assembly 1 and limit the external air from entering the wheel cavity 26 a minimally sized panel is positioned in the outer opening of the wheel cavity 26. The subject invention 50 is comprised of the minimally sized panel and associated attachment hardware. The subject invention 50 is sized and positioned according to the wheel cavity geometric characteristics. The subject invention 50 effectively closes the wheel cavity 26 to the external air flow. FIG. 3a shows an oblique view of the subject invention 50 installed on a single tire, wheel and hub assembly 1. The assembly is comprised of a tire 11, wheel 21, and hub 31. The wheel cavity 26 is the outward facing surface of the wheel 21 inboard of the wheel outer rim 25. FIG. 3b shows an oblique view of the subject invention 50 installed on a ground vehicle dual tire, wheel and hub assembly 2. The assembly is comprised of an outer tire 12, outer wheel 22, inner tire 13, inner wheel 23 (not shown) and hub 32. The wheel cavity 27 is the outward facing surface of the outer wheel 22 located inboard of the outer wheel outer rim 28.

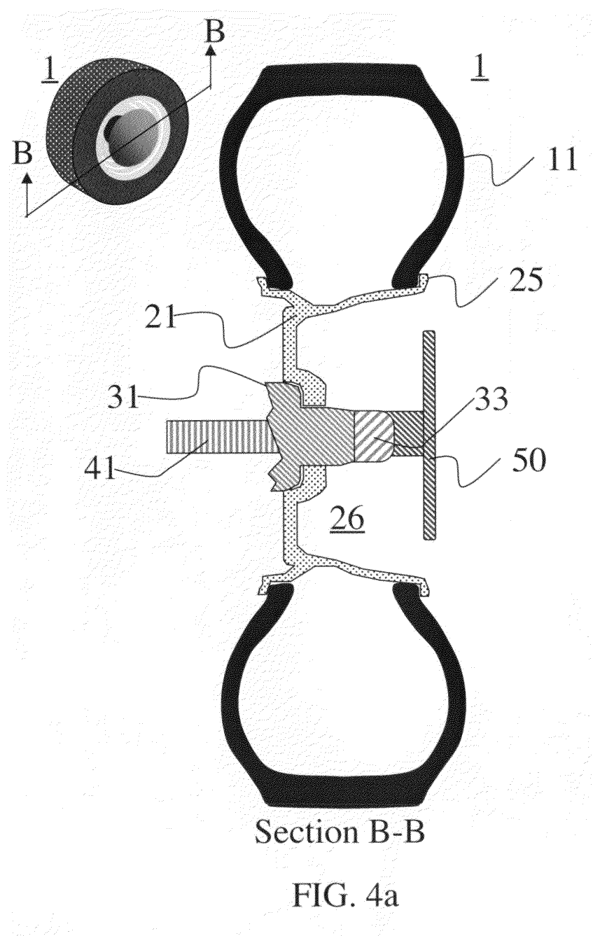

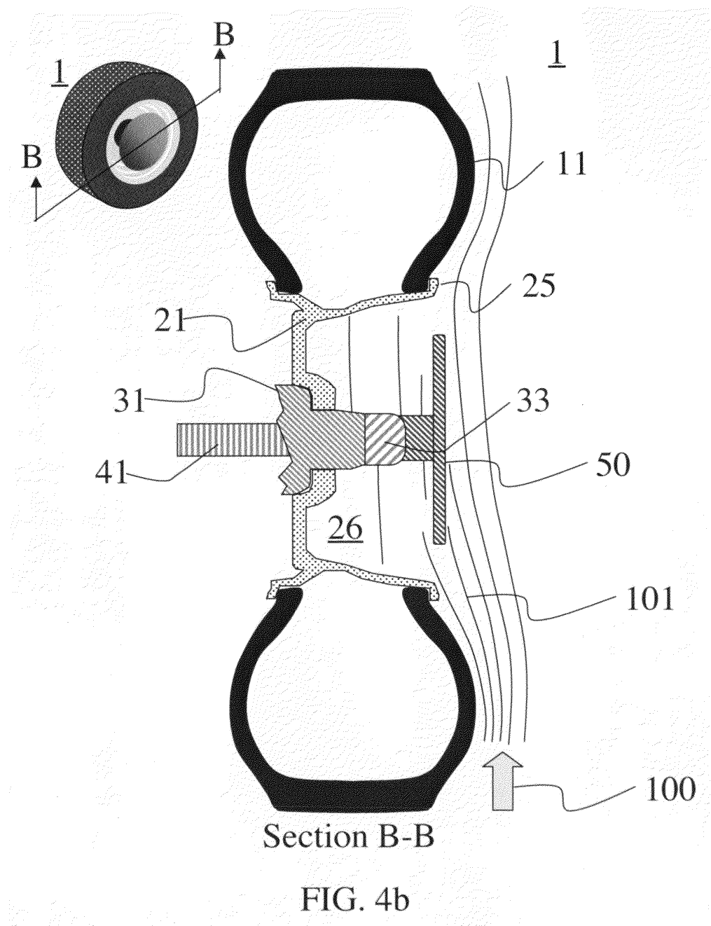

The wheel 21 and wheel cavity 26 of a single wheel assembly 1 and the wheel 22 and the wheel cavity 27 of a duel wheel assembly 2 have similar geometric characteristics. For this reason the details of a wheel assembly, subject invention 50 and the air flow features will be discussed for a single wheel assembly 1 in FIGS. 4 through 8.

FIG. 4a shows a cross section view B-B of the subject invention 50 installed on a single tire, wheel, and hub assembly 1. The cross section view B-B shows a typical relationship between the tire 11, wheel 21, axle 41, hub 31, hubcap 33 and subject invention 50. FIG. 4a also shows the wheel outer rim-edge 25 and the wheel cavity 26. FIG. 4a shows the subject invention 50 mounted to the wheel assembly 1 by means of an attachment to the hubcap 33. The means of attaching the subject invention 50 to the hubcap 33 may take various forms that include mechanical fasteners as well as bonding systems. The effectiveness of the subject invention 50 is dependent upon the relationship of the subject invention 50 to the geometric features of the wheel cavity 26. To maximize the aerodynamic, operational and maintenance benefits of the subject invention 50 the panel device of the invention 50 is sized to have less laterally projected area than the wheel cavity 26 and greater laterally projected area than the hub 31 or hubcap 33. The panel device of the invention 50 is orientated in a plane parallel to the plane of the wheel outer rim 25 and positioned laterally in close proximity to the plane of the wheel outer rim 25.

FIG. 4b shows a cross section view B-B of the air flow-streamlines passing over and into the wheel cavity 26 for a single tire, wheel, and hub assembly 1 with the subject invention 50 installed. The cross section view shows a typical relationship between the tire 11, wheel 21, axle 41, hub 31, hubcap 33 and subject invention 50. FIG. 4b also shows the wheel outer rim edge 25 and the wheel cavity 26. The free-stream air flow-direction 100 is opposite that of the vehicle direction. The majority of the external air flow-streamlines 101 are shown to pass over the wheel cavity 26. The subject invention 50 allows a small mass of external air 100 to enter the wheel cavity 26 where this air 102 fills the wheel cavity thereby restricting additional external air 100 from entering the wheel cavity 26 thereby effectively closing the wheel cavity 26 to additional external air 100 and 101 from entering the wheel cavity 26 and thus creating a closed cavity flow condition.

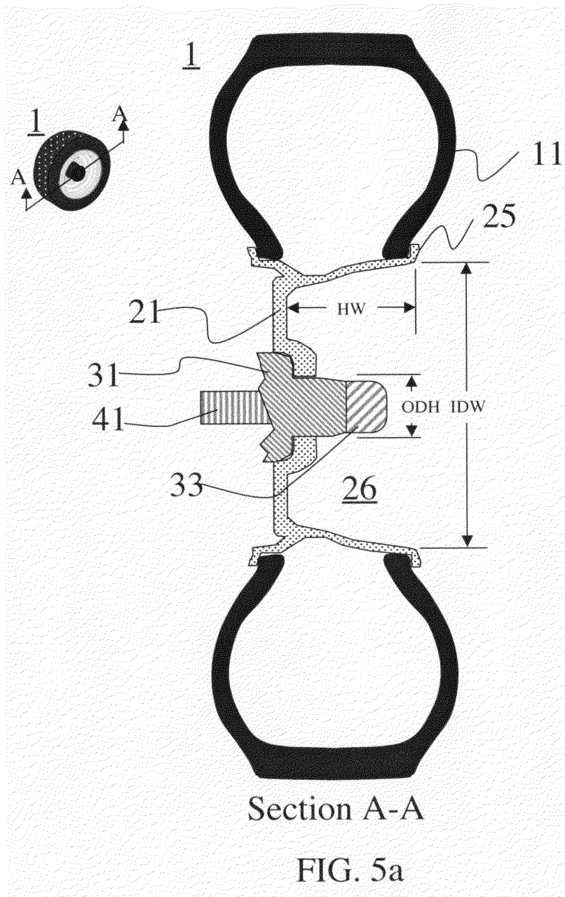

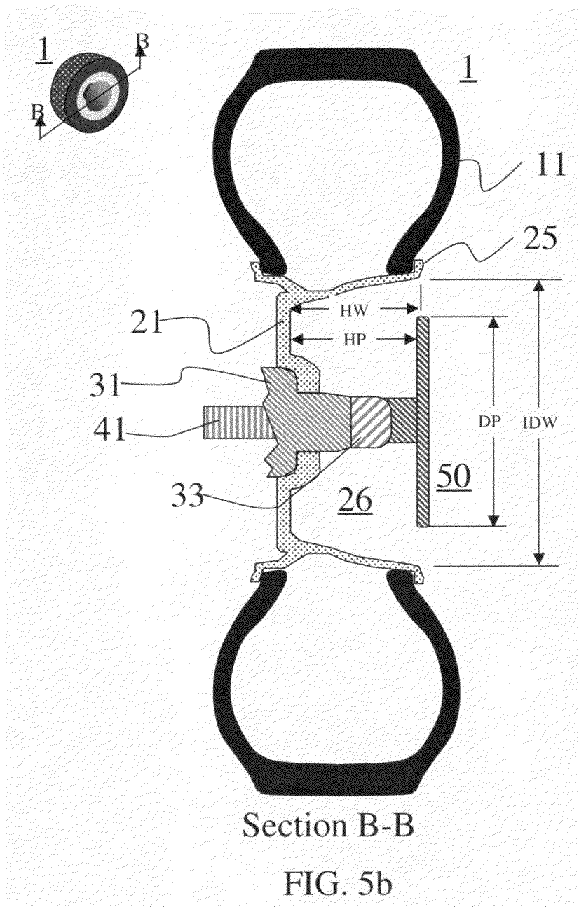

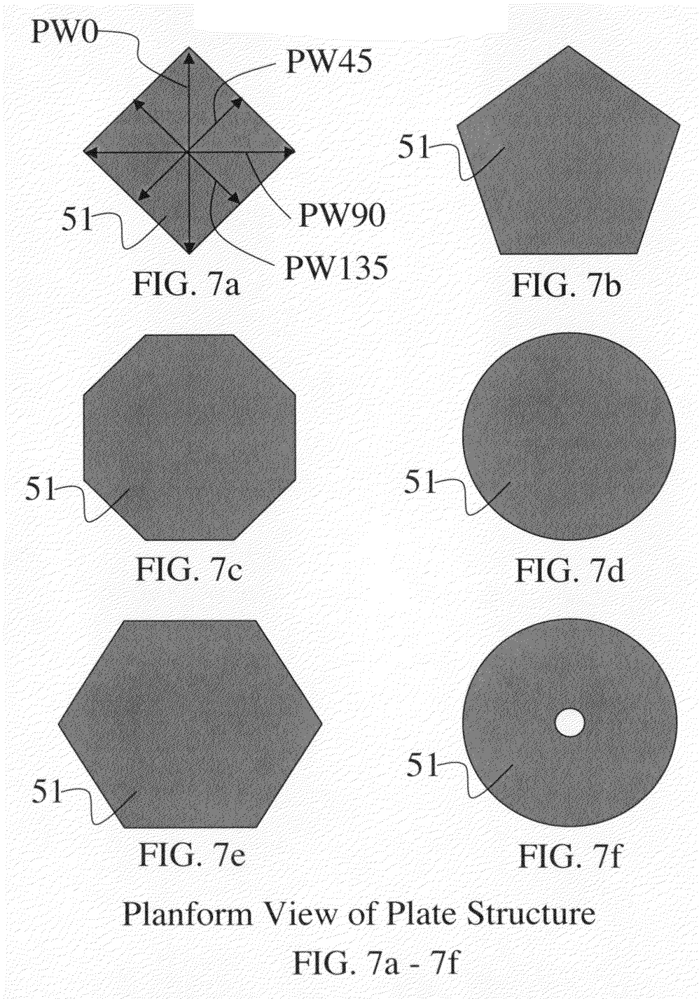

The benefits of the subject invention 50 are the ability to use a minimally sized panel device to stop external air from entering the wheel cavity 26 and thereby reduce the aerodynamic drag force on a ground vehicle wheel assembly 1. The invention 50 accomplishes this goal with a minimum sized panel device specifically sized to take advantage of advanced aerodynamic flow control technology to create a virtual cover over the opening of the wheel cavity 26. For the subject invention 50 to effectively control the air passing over the wheel cavity 26 a number of geometric parameters related to the wheel cavity 26 and the subject invention 50 must be satisfied. FIG. 5a depicts the critical geometric parameters that define the wheel cavity 26. The critical geometric parameters that define the size of the panel device of the subject invention 50 are shown in FIG. 5b. The wheel cavity 26 is defined by the height HW of the wheel cavity 26 and the inside diameter IDW of the wheel outer-rim 25. Another important parameter to note is the hub or hubcap outer diameter ODH. FIG. 5b depicts the two critical parameters that define the size and placement of the subject invention 50 in the wheel cavity 26 of a wheel assembly 1. The subject invention 50 is defined by its average diameter DP. The parameter DP is defined in FIG. 7a. The subject invention 50 will have a DP value that is greater than the hub outer diameter ODH and less than the wheel outer rim 25 inside diameter IDW. The dimension HP defines the lateral position of the subject invention 50 in the opening of the wheel cavity 26, where the parameter HP is approximately equal to the parameter HW. To maximize the aerodynamic, operational, and maintenance benefits of the subject invention 50 the panel device of the invention 50 is to be sized to cover an area that is less than the wheel cavity 26 maximum opening and greater than the laterally projected area of the hub 31 or hubcap 33. The panel device of the invention 50 is to be orientated in a plane parallel to the plane of the wheel outer rim 25 and positioned laterally in close proximity to the plane of the wheel outer rim 25.

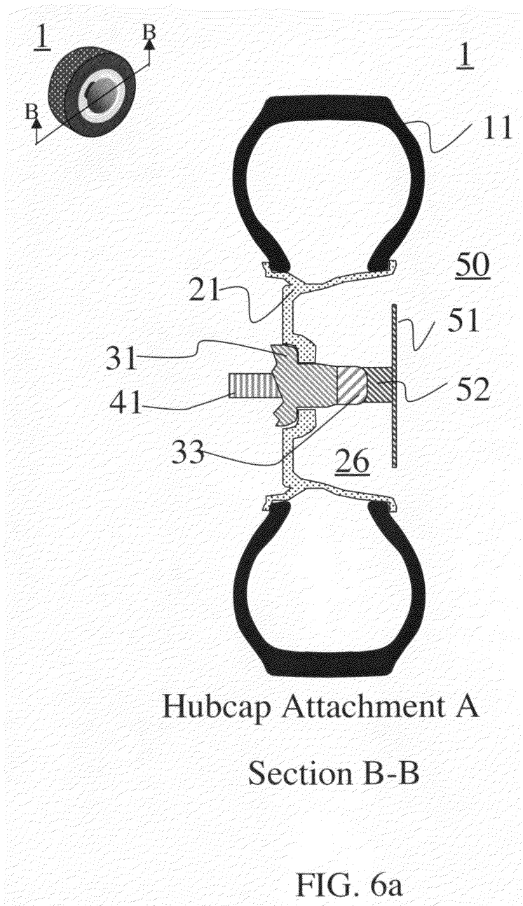

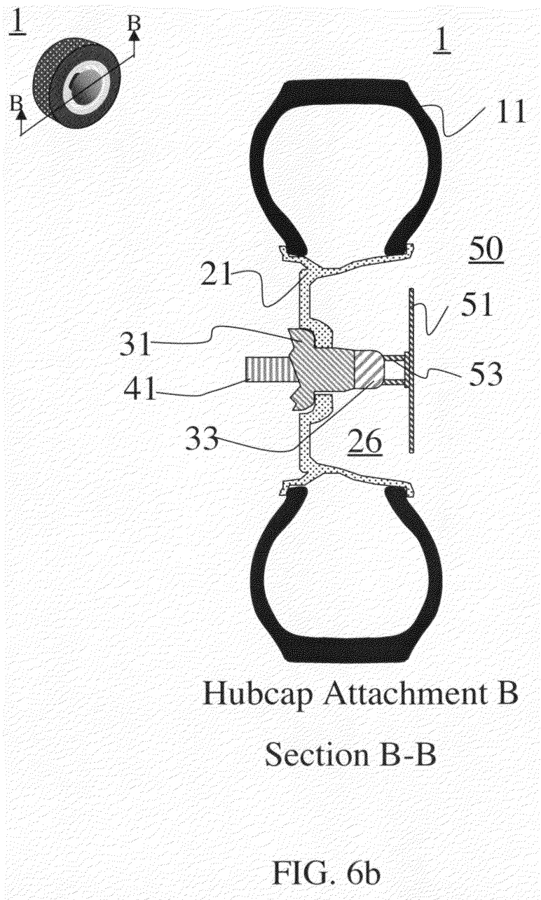

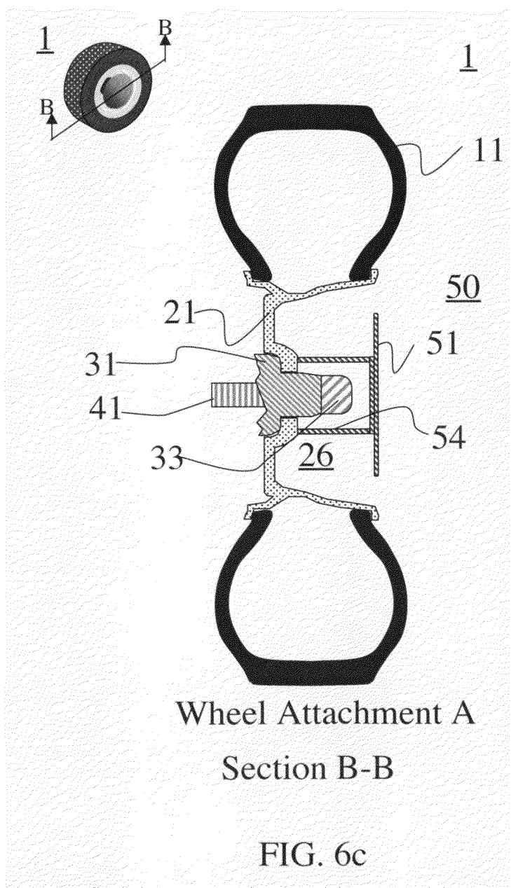

The subject invention 50 may be mounted to the wheel assembly 1 at various locations and through the use of various fastening devices. FIG. 6a shows one means for attaching the subject invention 50 to the hub 31 or hubcap 33 of a wheel assembly 1. The wheel assembly 1 is comprised of a tire 11, a wheel 21, axle 41, hub 31 and hubcap 33. The subject invention 50 is comprised of a panel device 51, an attachment bracket structure 52 and means for attaching the panel device 51 to the bracket structure 52 and means for attaching the bracket structure 52 to the hub 31 or hubcap 33. FIG. 6a shows a solid surface bracket structure 52. An alternative embodiment of the invention is to fabricate the subject invention 50 as a single component where the panel device 51 and the attachment bracket 52 are an integral unit.

FIG. 6b shows a second means for attaching the subject invention 50 to the hub 31 or hubcap 33 of a wheel assembly 1. The wheel assembly 1 is comprised of a tire 11, a wheel 21, axle 41, hub 31 and hubcap 33. The subject invention 50 is comprised of a panel device 51, an attachment bracket structure 53 and means for attaching the panel device 51 to the bracket structure 53 and means for attaching the bracket structure 53 to the hub 31 or hubcap 33. FIG. 6b shows a solid surface bracket structure 53. An alternative embodiment of the invention is to fabricate the subject invention 50 as a single component where the panel device 51 and the attachment bracket 53 are an integral unit.

FIG. 6c shows a means for attaching the subject invention 50 to the wheel 21 of a wheel assembly 1. The wheel assembly 1 is comprised of a tire 11, a wheel 21, axle 41, hub 31 and hubcap 33. The subject invention 50 is comprised of a panel device 51, an attachment bracket structure 54 and means for attaching the panel device 51 to the bracket structure 54 and means for attaching the bracket structure 54 to the wheel 21. FIG. 6c shows a bracket structure comprised of multiple attachment legs 54. An alternative embodiment of the invention is to fabricate the subject invention 50 as a single component where the panel device 51 and the attachment bracket 54 are an integral unit.

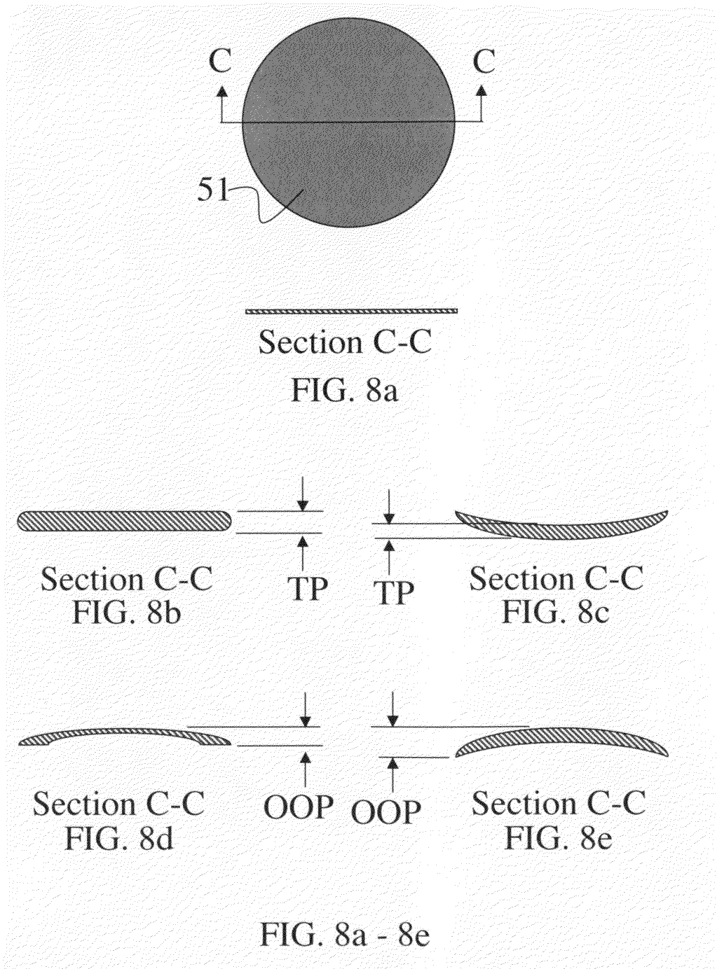

To accommodate various manufacturing requirements, materials, maintenance needs, and other engineering and operational concerns the subject invention may take various forms in planform shape and planform cross-section shape. FIG. 7 shows several representative planform shapes and FIG. 8 shows various representative planform cross-section shapes of the panel device 51 of the subject invention 50. FIGS. 7a through 7f show representative planform shapes of the panel device 51 of the subject invention 50. Also shown in FIG. 7a are the measurements used to calculate the effective diameter DP of the panel device 51. The value DP is defined as the average of at least four equally distributed width measurements of the subject panel device 51. A graphical representation of these measurements is shown in FIG. 7a where four width measurements are defined as; WP0, WP45, WP90, and WP135. The four widths are taken at 45° increments about the centroid of the panel device 51. The panel device 51 of the subject invention 50 may take various rectilinear and curvilinear forms to accommodate the operation, maintenance, cost, and aesthetic needs of the manufacturer and the user. FIG. 7a shows a panel device 51 with a square or diamond shaped planform. FIG. 7b shows a panel device 51 with a pentagon shaped planform. FIG. 7c shows a panel device 51 with an octagon shaped planform. FIG. 7d shows a panel device 51 with a circular shaped planform. FIG. 7e shows a panel device 51 with a hexagon shaped planform. FIG. 7f shows a panel device 51 with a donut shaped planform.

FIG. 8a through 8e show representative cross section cuts C-C of the panel device 51 of the subject invention 50. The panel device 51 of the subject invention 50 may take various forms to accommodate the operation, maintenance, cost, and aesthetic needs of the manufacturer and the user. The thickness TP of the panel device 51 shall be less than 50% of the wheel cavity height HW. The out-of-plane dimension OOP shall be less than 50% of the wheel cavity height HW

### Advantages

From the description provided above, a number of advantages of the subject device become evident:
The invention provides a novel process to reduce the drag of a ground vehicle.
(a) The invention provides a means to use closed cavity flow phenomena to reduce drag.
(b) The invention provides a means to reduce the aerodynamic drag and improve the operational efficiency of ground vehicles.
(c) The invention provides a means to reduce the aerodynamic drag and improve the fuel efficiency of ground vehicles.
(d) The invention provides a means to conserve energy and improve the operational efficiency of ground vehicles.
(e) The invention provides a means to reduce the aerodynamic drag without a significant geometric modification to existing ground vehicles.
(f) The invention may be easily applied to any existing ground vehicle or designed into any new ground vehicle.
(g) The invention allows for the efficient operation of the invention with a limited number of components.
(h) The invention allows for the matching of complex surface shapes by the shaping and placement of the components.
(i) The structure, placement, and shape of device may be adapted to meet specific performance or vehicle integration requirements.
(j) The outer edge shape of the device may be linear or complex to meet specific performance or vehicle integration requirements.
(k) The ability to optimally position the device in the wheel cavity.
(l) The ability to minimize weight and volume requirements of the device.
(m) The ability to minimize maintenance requirements.
(n) The ability to minimize the impact on operational and use characteristics of the vehicle.
(o) The ability to maximize the safety of vehicle operation.

### CONCLUSION, RAMIFICATIONS, AND SCOPE

Accordingly, the reader will see that the subject device can be used to easily and conveniently reduce aerodynamic drag on any ground vehicle for the purposes of improving the operational performance of the vehicle. Furthermore, the device has the additional advantages in that:
it reduces the aerodynamic drag force over the complete wheel surface;
it allows the contour of the host surface to be easily matched;
it allows easy application to any existing vehicle or designed into any existing vehicle;
it allows the device to be fabricated as an independent unit that may be applied to an existing surface;
it allows for optimal positioning relative to the wheel surface;
it allows for optimal attachment to the wheel surface;
it allows the design of a system with minimum weight and to require minimum volume;
it allows minimum maintenance requirements;
it allows minimum impact on wheel operation and use.
it allows for the maximum safety of vehicle operation;

Although the description above contains many specifics, these should not be construed as limiting the scope of the invention but as merely providing illustrations of some of the presently preferred embodiments of this invention. For example, the subject device can be composed of various rectilinear and curvilinear shapes such as ellipsoid, quadratic, etc.; the outer edge can be any rectilinear or curvilinear shape; the thickness and width of the subject panel device can vary; the material used to construct the panel device or attachment hardware can be any light-weight and structurally sound material such as wood, plastic, metal, composites, etc. The attachment hardware can be either conventional off the shelf or designed specifically for the subject invention.

The invention has been described relative to specific embodiments thereof and relative to specific vehicles, it is not so limited. The invention is considered applicable to any road vehicle including race cars automobiles, trucks, buses, trains, recreational vehicles, trailers, automobiles and campers. It is to be understood that various modifications and variation of the specific embodiments described herein will be readily apparent to those skilled in the art in light of the above teachings without departing from the spirit and scope.

Thus, the scope of the invention should be determined by the appended claims and their legal equivalents, rather than by the examples given.

What is claimed is:

1. An aerodynamic device for reducing drag on a ground vehicle, comprising:
a panel and means to attach the panel to the wheel and hub assembly of the vehicle;
wherein the panel is approximately positioned in the outward facing wheel cavity;
wherein the panel is approximately centered about the centerline of the wheel/hub assembly;
wherein the panel is aligned in a plane that is approximately parallel to the plane defined by the wheel rim;
wherein the panel is laterally positioned in close proximity to the plane defined by the wheel rim;
wherein the laterally projected area of the panel is less than the area defined by the wheel rim inside diameter;
wherein the laterally projected area of the panel is greater than the area defined by the hub outside diameter.

2. The aerodynamic device of claim 1, wherein the panel is comprised of multiple segments.

3. The aerodynamic device of claim 1, wherein the panel planform shape is rectilinear.

4. The aerodynamic device of claim 1, wherein the panel planform shape is curvilinear.

5. The aerodynamic device of claim 1, wherein the panel planform shape incorporates one or more notches.

6. The aerodynamic device of claim 1, wherein the panel planform shape incorporates one or more cutouts.

7. The aerodynamic device of claim 1, wherein the panel cross-section shape is of constant thickness.

8. The aerodynamic device of claim 1, wherein the panel cross-section shape is of varying thickness.

9. The aerodynamic device of claim 1, wherein the panel cross-section shape is concave.

10. The aerodynamic device of claim 1, wherein the panel cross-section shape is convex.

11. The aerodynamic device of claim 1, wherein the panel outer edge is aerodynamically sharp.

12. The aerodynamic device of claim 1, wherein the panel outer edge is aerodynamically blunt.

13. The aerodynamic device of claim 1, wherein the panel and attachment means is an integral unit.

14. The aerodynamic device of claim 1, wherein the panel and the attachment means are separate components.

15. The aerodynamic device of claim 1, wherein the attachment means are an integral unit.

16. An aerodynamic device for reducing drag on a ground vehicle, comprising:
a panel located with the outward facing wheel cavity of a wheel/hub assembly of the vehicle;
wherein the panel is positioned in the outward facing wheel cavity;
wherein the panel is approximately centered about the centerline of the wheel/hub assembly;
wherein the panel is aligned in a plane that is approximately parallel to the plane defined by the wheel rim;
wherein the panel is laterally positioned in close proximity to the plane defined by the wheel rim;
wherein the panel laterally projected area is less than the area defined by the wheel rim inside diameter;
wherein the panel laterally projected area is greater than the area defined by the hub outside diameter.

17. The aerodynamic device of claim 1, wherein the panel is comprised of multiple segments.

18. The aerodynamic device of claim 1, wherein the panel planform shape is rectilinear.

19. The aerodynamic device of claim 1, wherein the panel planform shape is curvilinear.

20. The aerodynamic device of claim 1, wherein the panel planform shape incorporates one or more notches.

21. The aerodynamic device of claim 1, wherein the panel planform shape incorporates one or more cutouts.

22. The aerodynamic device of claim 1, wherein the panel cross-section shape is of constant thickness.

23. The aerodynamic device of claim 1, wherein the panel cross-section shape is of varying thickness.

24. The aerodynamic device of claim 1, wherein the panel cross-section shape is concave.

25. The aerodynamic device of claim 1, wherein the panel cross-section shape is convex.

26. The aerodynamic device of claim 1, wherein the panel outer edge is aerodynamically sharp.

27. The aerodynamic device of claim 1, wherein the panel outer edge is aerodynamically blunt.
